(19) United States
(12) Patent Application Publication
(10) Pub. No.: US 2026/0358575 A1
(43) Pub. Date: Nov. 12, 2026

(54) SEMICONDUCTOR PACKAGE INCLUDING WAVEGUIDES

(71) Applicant: Samsung Electronics Co., Ltd., Suwon-si (KR)

(72) Inventors: Changbo LEE, Suwon-si (KR); Seung Ho LEE, Suwon-si (KR); Hunjae JANG, Suwon-si (KR)

(21) Appl. No.: 19/425,202

(22) Filed: Dec. 18, 2025

(30) Foreign Application Priority Data
May 12, 2025 (KR) 10-2025-0061487

(51) Int. Cl. G02B 6/42

(52) U.S. Cl. CPC G02B 6/4214

(57) ABSTRACT

A semiconductor package includes an optical fiber configured to transmit an optical signal, a photonic integrated circuit chip configured to convert the optical signal received from the optical fiber into an electrical signal, an electric circuit configured to receive the electrical signal, and a waveguide structure connecting the optical fiber and the photonic integrated circuit chip, and configured to transmit the optical signal to the photonic integrated circuit chip, wherein the waveguide structure includes a first waveguide extending in a first direction, a mirror including a reflection surface which is configured to reflect the optical signal in the first waveguide toward a second direction that is a direction to be adjacent to the photonic integrated circuit chip, and a second waveguide into which the optical signal reflected from the reflection surface is incident, and extending in the second direction from the first waveguide.

### CROSS-REFERENCE TO RELATED APPLICATION(S)

This application claims the benefit of Korean Patent Application No. 10-2025-0061487, filed on May 12, 2025, in the Korean Intellectual Property Office, the disclosure of which is incorporated herein by reference in its entirety.

### BACKGROUND

As the electronics industry develops, the demand for high-performance, high-speed, and miniaturized electronic components is increasing. Some techniques employ a method of stacking multiple semiconductor chips on a single package interconnection structure or stacking packages on top of other packages. For example, a package-in-package (PIP) type semiconductor package or a package-on-package (POP) type semiconductor package can be used.

Meanwhile, as semiconductor packages become more integrated, a vertical interconnection structure can be used with semiconductor chips that are stacked and are electrically connected.

### SUMMARY

The present application relates to a semiconductor package.

An aspect provides a semiconductor package including a waveguide structure for transmitting optical signals.

Another aspect provides optimizing the waveguide structure for optical signal transmission.

The example implementations are not limited to the techniques described above, and other techniques may be inferred from the following example implementations by those skilled in the art.

According to an aspect, there is provided a semiconductor package including optical fiber configured to transmit an optical signal, a photonic integrated circuit chip configured to convert the optical signal received from the optical fiber into an electrical signal, an electric circuit configured to receive the electrical signal that is converted in the photonic integrated circuit chip, and a waveguide structure connecting the optical fiber and the photonic integrated circuit chip, and configured to transmit the optical signal to the photonic integrated circuit chip. The waveguide structure includes a first waveguide extending in a first direction, a mirror including a reflection surface which is configured to reflect the optical signal in the first waveguide toward a second direction that is a direction to be adjacent to the photonic integrated circuit chip, and a second waveguide into which the optical signal reflected from the reflection surface is incident, and extending in the second direction from the first waveguide toward the photonic integrated circuit chip.

According to another aspect, there is provided a semiconductor package including optical fiber, a die including a first surface and a first connection waveguide that is extending to the first surface and configured to transmit an optical signal incident through the optical fiber, and a chip including a second surface facing the first surface and a second connection waveguide extending toward the second surface in order to receive the optical signal through the first connection waveguide. The die and the chip are stacked to each other, and the first surface and the second surface are bonded to each other in a state that the first connection waveguide and the second connection waveguide are aligned in a direction in which the die and the chip are stacked.

According to another aspect, there is provided a semiconductor package including optical fiber, and a waveguide structure configured to transmit an optical signal incident through the optical fiber to a photonic integrated circuit chip. The waveguide structure includes a mirror including a reflection surface, and a first waveguide extending toward the mirror, and including a first waveguide surface that is in contact with the reflection surface.

Specific details of other example implementations are included in the detailed description and drawings.

According to example implementations, it is possible to provide a semiconductor package by which optical signals can be transmitted through a first waveguide and a second waveguide that extend in intersecting directions.

According to example implementations, it is possible to provide a semiconductor package by which the waveguide structure can be optimized for optical signal transmission through an arrangement structure and a connection structure of a first waveguide, a second waveguide and a mirror.

### BRIEF DESCRIPTION OF THE DRAWINGS

These and/or other aspects, features, and advantages of the disclosure will become apparent and more readily appreciated from the following description of example implementations, taken in conjunction with the accompanying drawings.

FIG. 1 is a perspective view of a semiconductor package according to some implementations.

FIG. 2 is a cross-sectional view of a semiconductor package according to some implementations.

FIG. 3 is an enlarged view of a portion of a cross-sectional view of a semiconductor package according to some implementations.

FIG. 4 is an enlarged view of a portion of a cross-sectional view of a semiconductor package according to some implementations.

FIG. 5 is a block diagram illustrating a method for manufacturing a waveguide structure according to some implementations.

FIG. 6A is a drawing illustrating a method for manufacturing a waveguide structure according to some implementations.

FIG. 6B is a drawing illustrating a method for manufacturing a waveguide structure according to some implementations.

FIG. 7A is a drawing illustrating a method for manufacturing a waveguide structure according to some implementations.

FIG. 7B is a drawing illustrating a method for manufacturing a waveguide structure according to some implementations.

FIG. 8A is a drawing illustrating a method for manufacturing a waveguide structure according to some implementations.

FIG. 8B is a drawing illustrating a method for manufacturing a waveguide structure according to some implementations.

FIG. 9A is a drawing illustrating a method for manufacturing a waveguide structure according to some implementations.

FIG. 9B is a drawing illustrating a method for manufacturing a waveguide structure according to some implementations.

FIG. 10A is a drawing illustrating a method for manufacturing a waveguide structure according to some implementations.

FIG. 10B is a drawing illustrating a method for manufacturing a waveguide structure according to some implementations.

FIG. 11A is a drawing illustrating a method for manufacturing a waveguide structure according to some implementations.

FIG. 11B is a drawing illustrating a method for manufacturing a waveguide structure according to some implementations.

FIG. 12A is a drawing illustrating a method for manufacturing a waveguide structure according to some implementations.

FIG. 12B is a drawing illustrating a method for manufacturing a waveguide structure according to some implementations.

FIG. 13A is a drawing illustrating a method for manufacturing a waveguide structure according to some implementations.

FIG. 13B is a drawing illustrating a method for manufacturing a waveguide structure according to some implementations.

FIG. 14A is a drawing illustrating a method for manufacturing a waveguide structure according to some implementations.

FIG. 14B is a drawing illustrating a method for manufacturing a waveguide structure according to some implementations.

FIG. 15A is a drawing illustrating a method for manufacturing a waveguide structure according to some implementations.

FIG. 15B is a drawing illustrating a method for manufacturing a waveguide structure according to some implementations.

FIG. 16A is a drawing illustrating a method for manufacturing a waveguide structure according to some implementations. and

FIG. 16B is a drawing illustrating a method for manufacturing a waveguide structure according to some implementations.

### DETAILED DESCRIPTION

Prior to the detailed description of the present disclosure, terms or words used in the specification and claims should not be construed as limited to their common or dictionary meanings. Further, the terms or words should be interpreted with meaning and concept consistent with the technical idea of the present disclosure. The example implementations described in this specification and the configurations shown in the drawings do not necessarily represent the entire technical idea of the present disclosure. Accordingly, at the time of filing the present disclosure, there may be various equivalents and modifications that can replace them.

In the following description, singular expressions include plural expressions unless the context clearly dictates otherwise. It will be understood that, when an element (for example, a first element) is "(operatively or communicatively) coupled with/to" or "connected to" another element (for example, a second element), the element may be directly coupled with/to another element, and there may be an intervening element (for example, a third element) between the element and another element. The terms "have," "may have," "include," and "may include" as used herein indicate the presence of corresponding features (for example, elements such as numerical values, functions, operations, or parts), and do not preclude the presence of additional features.

In the present disclosure, singular expressions include plural expressions unless the context clearly indicates otherwise. Further, terms "first," "second" and so on may be used to describe various components. However, the components are not limited by the terms, and the terms may be used for the purpose of distinguishing one component from another. Within the scope of the technical idea of the present disclosure, the first component may be named as the second component. Similarly, the second component may also be named the first component. Further, the shape and size of components may be exaggerated to emphasize clear explanation.

Further, in the following description, expressions such as an upper side, top, a lower side, bottom, a side, front and a back side are expressed based on the direction shown in the drawing. If the direction of the object changes, it may be expressed differently. The shapes and sizes of elements in the drawings may be exaggerated for clearer explanation.

Hereinafter, example implementations according to the present disclosure will be described with reference to the attached drawings.

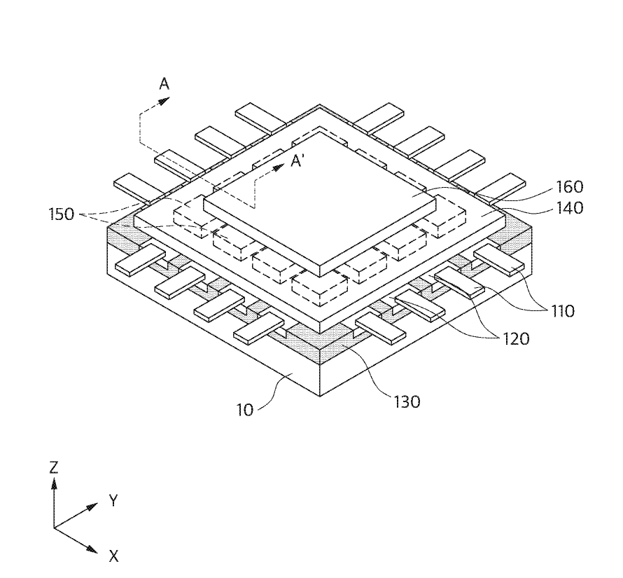

FIG. 1 is a perspective view of a semiconductor package 1 according to some implementations.

According to some example implementations, the semiconductor package 1 may include a package substrate 10, optical fiber 110, a light-receiving structure 120, a first die 130, a second die 140, a chip assembly 150, and a semiconductor chip 160. Hereinafter, unless otherwise specified, the direction parallel to the top surface of the package substrate 10 is defined as the first direction (the X direction), the direction perpendicular to the top surface of the package substrate 10 is defined as the second direction (the Z direction), and the direction perpendicular to the first direction (the X direction) and the second direction (the Z direction) is defined as the third direction (the Y direction).

According to some example implementations, the package substrate 10 may be a printed circuit board (PCB). The package substrate 10 may include at least one material selected from phenol resin, epoxy resin and polyimide. For example, the package substrate 10 may include at least one material selected from polyimide, flame retardant 4 (FR-4), tetrafunctional epoxy, polyphenylene ether, epoxy/polyphenylene oxide, bismaleimide triazine (BT), thermount, cyanate ester, and liquid crystal polymer.

According to some example implementations, the optical fiber 110 may transmit optical signals. The optical fiber 110 may output an optical signal. The optical fiber 110 may transmit an optical signal transmitted from an external device to the chip assembly 150. The optical fiber 110 may output the optical signal transmitted from the chip assembly 150 to an external device.

According to some example implementations, the light-receiving structure 120 may receive an optical signal from the optical fiber 110. The light-receiving structure 120 may transmit an optical signal to the optical fiber 110. The light-receiving structure 120 may face the optical fiber 110 in the second direction (the Z direction). The optical fiber 110 and the light-receiving structure 120 may be optically connected.

According to some example implementations, the first die 130 may be stacked on the package substrate 10. The first die 130 may provide a light path for an optical signal transmitted through the optical fiber 110. The light-receiving structure 120 may be placed between the optical fiber 110 and the first die 130. The optical fiber 110, the light-receiving structure 120 and the first die 130 may be optically connected to each other. An optical signal transmitted through the optical fiber 110 may pass through the light-receiving structure 120 and the first die 130 to the chip assembly 150. The optical signal transmitted from the chip assembly 150 may be output to an external device through the first die 130, the light-receiving structure 120, and the optical fiber 110. The first die 130 may be named "die."

According to some example implementations, the second die 140 may be laminated on the first die 130. The second die 140 may surround the chip assembly 150. For example, the second die 140 may include a molding film including an epoxy molding compound (EMC) material surrounding the chip assembly 150.

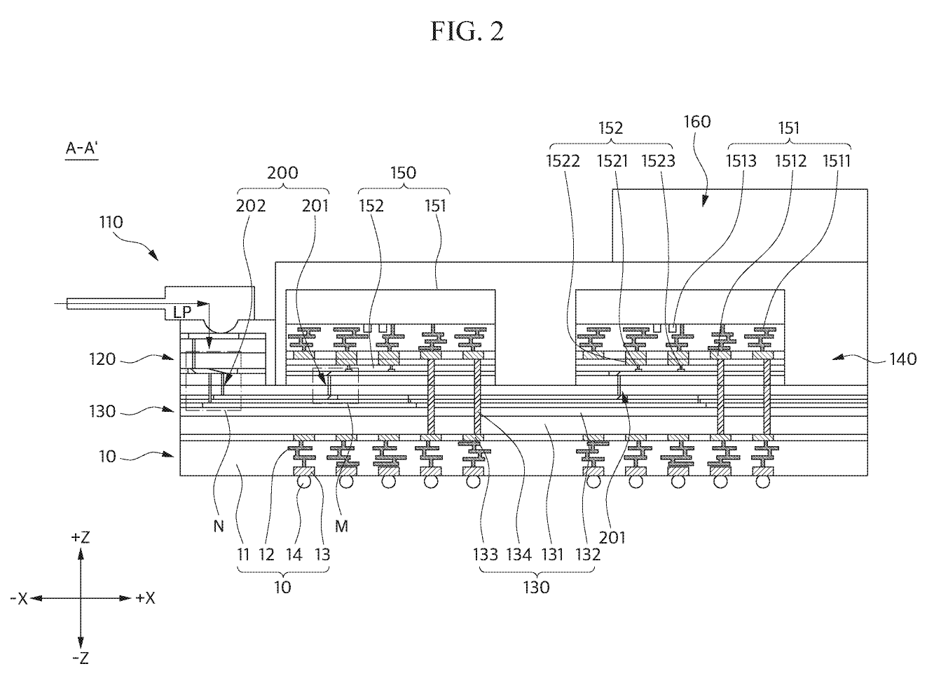

According to some example implementations, the chip assembly 150 may be surrounded by the second die 140. The chip assembly 150 may be placed inside the second die 140. The chip assembly 150 may be stacked with the first die 130. The chip assembly 150 may receive optical signals through the first die 130. For example, a photonic integrated circuit chip of the chip assembly 150 (for example, a photonic integrated circuit chip 152 of FIG. 2) may receive an optical signal through a waveguide structure of the first die 130 (for example, a waveguide structure 200 of FIG. 2). The chip assembly 150 may transmit the optical signals toward the first die 130. For example, the photonic integrated circuit chip 152 of the chip assembly 150 may transmit an optical signal toward the waveguide structure 200 of the first die 130. The chip assembly 150 may be referred to as "chip."

In some example implementations, the semiconductor chip 160 may include multiple individual devices of various types. For example, the individual devices may include a variety of microelectronic devices. For example, included may be metal-oxide-semiconductor field effect transistors (MOSFET), such as complementary metal-insulator-semiconductor (CMOS) transistors, system large scale integration (LSI) circuits, image sensors such as flash memory, DRAM, SRAM, EEPROM, PRAM, MRAM, RRAM, CMOS imaging sensors (CIS), micro-electro-mechanical systems (MEMS), active devices, and/or passive devices.

FIG. 2 is a cross-sectional view of a semiconductor package according to some implementations. FIG. 2 may be a cross-sectional view along the A-A' reference line illustrated in FIG. 1.

According to some example implementations, the chip assembly 150 may include an electronic integrated circuit chip 151. The electronic integrated circuit chip 151 may process, operate, store, control, communicate, or transmit electrical signals. For example, the electronic integrated circuit chip 151 may transmit electrical signals to the semiconductor chip 160.

According to some example implementations, the electronic integrated circuit chip 151 may include an electric circuit 1511, a first pad 1512, and an electric device 1513. The electric device 1513 may process, operate, store, control, communicate, or transmit electrical signals. The electric circuit 1511 may be connected to the electric device 1513. The electric circuit 1511 may transmit an electrical signal to the electric device 1513, and receive the electrical signal from the electric device 1513. The first pad 1512 may be connected to the electric circuit 1511. The first pad 1512 may connect external components of the electronic integrated circuit chip 151 and the electric circuit 1511.

According to some example implementations, the chip assembly 150 may include the photonic integrated circuit chip 152. The photonic integrated circuit chip 152 may convert optical signals into electrical signals. The photonic integrated circuit chip 152 may convert electrical signals into optical signals.

According to some example implementations, the photonic integrated circuit chip 152 may include an optical integrated circuit 1521, a second pad 1522, and an optical device 1523. The optical device 1523 may convert an optical signal into an electrical signal. The optical device 1523 may convert an electrical signal into an optical signal. The optical device 1523 may include components included in a photonic integrated circuit chip (for example, a photodetector, a photodiode, a modulator and so on). The optical integrated circuit 1521 may be connected to the optical device 1523. The optical integrated circuit 1521 may transmit an optical signal to the optical device 1523, and receive the optical signal from the optical device 1523. The second pad 1522 may be connected to the optical integrated circuit 1521. The second pad 1522 may connect external components of the photonic integrated circuit chip 152 and the optical integrated circuit 1521.

According to some example implementations, the electronic integrated circuit chip 151 and the photonic integrated circuit chip 152 may be stacked. The electronic integrated circuit chip 151 and the photonic integrated circuit chip 152 may be electrically connected. The first pad 1512 and the second pad 1522 may be bonded. The electric circuit 1511 and the optical integrated circuit 1521 may be electrically connected through the first pad 1512 and the second pad 1522.

According to some example implementations, the photonic integrated circuit chip 152 may convert an optical signal into an electrical signal and transmit the electrical signal to the electric circuit 1511. The optical signal transmitted to the photonic integrated circuit chip 152 may be converted into an electrical signal by the optical device 1523, and the converted electrical signal may be transmitted to the electric circuit 1511.

According to some example implementations, the photonic integrated circuit chip 152 may convert an electrical signal into an optical signal and transmit the optical signal through the optical fiber 110. An electrical signal transmitted from the electronic integrated circuit chip 151 may be converted into an optical signal by the optical device 1523, and the converted optical signal may be transmitted to the optical fiber 110 through the waveguide structure 200.

According to some example implementations, the chip assembly 150 may transmit an electrical signal to the semiconductor chip 160. An optical signal transmitted to the photonic integrated circuit chip 152 may be converted into an electrical signal by the optical device 1523 and then transmitted to the semiconductor chip 160.

According to some example implementations, the chip assembly 150 may be connected to the package substrate 10. The package substrate 10 may include a substrate insulation layer 11, a substrate interconnection 12, a substrate pad 13, and a substrate connections structure 14. The substrate insulation layer 11 may surround the substrate interconnection 12. The electrical signals transmitted from the chip assembly 150 may be transmitted to external devices through the substrate interconnection 12, the substrate pad 13, and the substrate connections structure 14. An electrical signal transmitted from an external device may be transmitted to the chip assembly 150 through the substrate connections structure 14, the substrate pad 13, and the substrate interconnection 12.

According to some example implementations, the first die 130 may include a die substrate layer 131 and an optical passage layer 132. The die substrate layer 131 and the optical passage layer 132 may be stacked. The die substrate layer 131 may be placed between the package substrate 10 and the optical passage layer 132. The die substrate layer 131 may include an insulating material.

According to some example implementations, the first die 130 may include a die pad 133 and a through via 134. The die pad 133 may be connected to the substrate interconnection 12 of the package substrate 10. The through via 134 may be extended through the first die 130. The through via 134 may penetrate the die substrate layer 131 and the optical passage layer 132. The through via 134 may be connected to the die pad 133. The through via 134 may be electrically connected to the electronic integrated circuit chip 151 of the chip assembly 150. The through via 134 may connect the electronic integrated circuit chip 151 and the package substrate 10. The electronic integrated circuit chip 151 may receive electrical signals from the package substrate 10 through the through via 134, and transmit the electrical signals to the package substrate 10 through the through via 134.

According to some example implementations, the semiconductor package 1 may include the waveguide structure 200. The waveguide structure 200 may transmit optical signals. The waveguide structure 200 may transmit an optical signal transmitted from the optical fiber 110 to the photonic integrated circuit chip 152. The waveguide structure 200 may transmit an optical signal transmitted from the photonic integrated circuit chip 152 to the optical fiber 110.

According to some example implementations, the waveguide structure 200 may indicate "a structure through which an optical signal is transmitted." In other words, the waveguide structure 200 may be defined as the entire structure that provides a passage through which an optical signal is transmitted within the semiconductor package 1.

According to some example implementations, at least a portion of the waveguide structure 200 may be formed within the light-receiving structure 120. At least a portion of the waveguide structure 200 may be formed within the first die 130. At least a portion of the waveguide structure 200 may be formed within the photonic integrated circuit chip 152.

According to some example implementations, the waveguide structure 200 may include a first waveguide structure 201 that optically connects the first die 130 and the photonic integrated circuit chip 152. At least a portion of the first waveguide structure 201 may be located within the first die 130. At least a portion of the first waveguide structure 201 may be located within the photonic integrated circuit chip 152. The first waveguide structure 201 may transmit an optical signal transmitted within the first die 130 to the photonic integrated circuit chip 152. The first waveguide structure 201 may transmit an optical signal transmitted within the photonic integrated circuit chip 152 to the first die 130.

According to some example implementations, the waveguide structure 200 may include a second waveguide structure 202 that optically connects the light- receiving structure 120 and the first die 130. At least a portion of the second waveguide structure 202 may be located within the light-receiving structure 120. At least a part of the second waveguide structure 202 may be located within the first die 130. The second waveguide structure 202 may transmit an optical signal transmitted within the light-receiving structure 120 to the first die 130. The second waveguide structure 202 may transmit the optical signal transmitted within the first die 130 to the light-receiving structure 120.

According to some example implementations, an optical signal transmitted through the optical fiber 110 may be transmitted to the waveguide structure 200 along a light path (LP), and be transmitted to the photonic integrated circuit chip 152 along the waveguide structure 200.

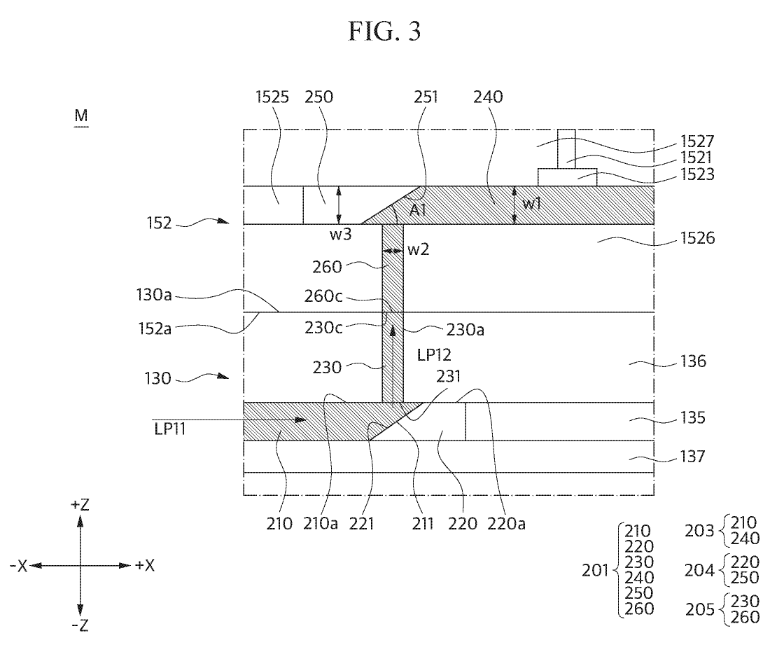

FIG. 3 is an enlarged view of a portion of a cross-sectional view of a semiconductor package according to some implementations. FIG. 3 may be an enlarged view of the M region illustrated in FIG. 2.

According to some example implementations, the waveguide structure 200 may include a first waveguide 203. The first waveguide 203 may be extended in the first direction (for example, the +X direction). The first waveguide 203 may transmit an optical signal along the first direction. For example, a first light path LP11 through which an optical signal is transmitted may be formed inside the first waveguide 203.

According to some example implementations, the first waveguide 203 may include a 1-1 waveguide 210 and a 1-2 waveguide 240. The 1-1 waveguide 210 may be placed inside the first die 130. The 1-1 waveguide 210 may extend in the first direction (for example, the +X direction) within the first die 130. The 1-2 waveguide 240 may be placed inside the photonic integrated circuit chip 152. The 1-2 waveguide 240 may extend in the first direction (for example, the +X direction) inside the photonic integrated circuit chip 152. The 1-1 waveguide 210 and the 1-2 waveguide 240 may be extended parallel to each other. The 1-1 waveguide 210 and the 1-2 waveguide 240 may be separated from each other in a second direction (for example, the +Z direction) perpendicular to the first direction.

According to some example implementations, the waveguide structure 200 may include a second waveguide 205. The second waveguide 205 may extend in the second direction (for example, the +Z direction) that is intersecting (for example, orthogonal) to the first direction (for example, +X direction). The second waveguide 205 may transmit an optical signal along the second direction. For example, a second light path LP12 through which the optical signal is transmitted may be formed inside the second waveguide 205.

According to some example implementations, the second waveguide 205 may include a 2-1 waveguide 230 and a second waveguide 260. The 2-1 waveguide 230 may be placed inside the first die 130. The 2-1 waveguide 230 may extend in the second direction (for example, the +Z direction) within the first die 130. The second waveguide 260 may be placed inside the photonic integrated circuit chip 152. The second waveguide 260 may extend in the second direction (for example, the +Z direction) within the photonic integrated circuit chip 152. The 2-1 waveguide 230 and the second waveguide 260 may be extended parallel to each other. The 2-1 waveguide 230 and the second waveguide 260 may be aligned in the second direction. The 2-1 waveguide 230 may be named the "first connection waveguide." The second waveguide 260 may be named the "second connection waveguide."

According to some example implementations, the waveguide structure 200 may include a mirror 204. The mirror 204 may reflect an optical signal transmitted through the waveguide structure 200. For example, the mirror 204 may reflect the optical signal transmitted through the first waveguide 203 toward the second waveguide 205. For example, the mirror 204 may reflect the optical signal transmitted through the second waveguide 205 toward the first waveguide 203. The mirror 204 may face each of the first waveguide 203 and the second waveguide 205.

According to some example implementations, the mirror 204 may include a first mirror 220. The first mirror 220 may be placed inside the first die 130. The first mirror 220 may face the 1-1 waveguide 210 inside the first die 130. The first mirror 220 may face the 2-1 waveguide 230 inside the first die 130. The first mirror 220 may reflect the optical signal transmitted through the 1-1 waveguide 210 toward the 2-1 waveguide 230. The first mirror 220 may reflect the optical signal transmitted through the 2-1 waveguide 230 toward the 1-1 waveguide 210.

According to some example implementations, the mirror 204 may include a second mirror 250. The second mirror 250 may be placed inside the photonic integrated circuit chip 152. The second mirror 250 may face the 1-2 waveguide 240 inside the photonic integrated circuit chip 152. The second mirror 250 may face the second waveguide 260 inside the photonic integrated circuit chip 152. The second mirror 250 may reflect the optical signal transmitted through the 1-2 waveguide 240 toward the second waveguide 260. The second mirror 250 may reflect the optical signal transmitted through the second waveguide 260 toward the 1-2 waveguide 240.

According to some example implementations, the first waveguide structure 201 may include the 1-1 waveguide 210, the first mirror 220, the 2-1 waveguide 230, the 1-2 waveguide 240, the second mirror 250, and the second waveguide 260.

According to some example implementations, an optical signal may be transmitted to the optical device 1523 through the first waveguide structure 201. The optical signal transmitted to the optical device 1523 may be converted into an electrical signal by the optical device 1523.

According to some example implementations, the mirror 204 may include reflection surfaces (a first reflection surface 221 and a second reflection surface 251). The reflection surfaces (the first reflection surface 221 and the second reflection surface 251) may reflect the optical signal transmitted through the waveguide structure 200. For example, the reflection surfaces (the first reflection surface 221 and the second reflection surface 251) may reflect the optical signal transmitted through the first waveguide 203 toward the second waveguide 205. For example, the reflection surfaces (the first reflection surface 221 and the second reflection surface 251) may reflect the optical signal transmitted through the second waveguide 205 toward the first waveguide 203.

According to some example implementations, the first mirror 220 may include the first reflection surface 221. The first reflection surface 221 may face the 1-1 waveguide 210. The first reflection surface 221 may face the 2-1 waveguide 230. The first reflection surface 221 may reflect the optical signal transmitted through the 1-1 waveguide 210 toward the 2-1 waveguide 230. The first reflection surface 221 may reflect the optical signal transmitted through the 2-1 waveguide 230 toward the 1-1 waveguide 210.

According to some example implementations, the second mirror 250 may include the second reflection surface 251. The second reflection surface 251 may face the 1-2 waveguide 240. The second reflection surface 251 may face the second waveguide 260. The second reflection surface 251 may reflect the optical signal transmitted through the 1-2 waveguide 240 toward the second waveguide 260. The second reflection surface 251 may reflect the optical signal transmitted through the second waveguide 260 toward the 1-2 waveguide 240.

According to some example implementations, the reflection surfaces (the first reflection surface 221 and the second reflection surface 251) may be in contact with the first waveguide 203. The first waveguide 203 may include a first waveguide surface 211 in contact with reflection surfaces (the first reflection surface 221 and the second reflection surface 251). For example, the 1-1 waveguide 210 may include the first waveguide surface 211 in contact with the first reflection surface 221.

According to some example implementations, the reflection surfaces (the first reflection surface 221 and the second reflection surface 251) may be inclined with respect to the first direction (for example, the +X direction). The reflection surfaces (the first reflection surface 221 and the second reflection surface 251) may be inclined with respect to the direction in which the first waveguide 203 extends. The reflection surfaces (the first reflection surface 221 and the second reflection surface 251) may have an inclination angle A1 with respect to the first direction. The inclination angle A1 may be formed within a range of 40 to 50 degrees. The inclination angle A1 may be 45 degrees. The first waveguide surface 211 may be inclined at the same angle as the reflection surfaces (the first reflection surface 221 and the second reflection surface 251). For example, the first waveguide surface 211 may be inclined by the inclination angle A1 with respect to the first direction.

According to some example implementations, the second waveguide 205 may extend from the first waveguide 203. The first waveguide 203 may include a first perimeter surface 210a. For example, the 1-1 waveguide 210 may include the first perimeter surface 210a. The second waveguide 205 may extend from the first perimeter surface 210a of the first waveguide 203. The second waveguide 205 may include a second waveguide surface 231 in contact with the first perimeter surface 210a of the first waveguide 203. For example, the 2-1 waveguide 230 may include the second waveguide surface 231 in contact with the first perimeter surface 210a. The second waveguide surface 231 may face the mirror 204. For example, the second waveguide surface 231 may face the first reflection surface 221 of the first mirror 220.

According to some example implementations, the mirror 204 may include a mirror surface 220a aligned with the first perimeter surface 210a of the first waveguide 203. The first perimeter surface 210a and the mirror surface 220a may be located on the same plane.

According to some example implementations, the reflection surfaces (the first reflection surface 221 and the second reflection surface 251) may face both the first waveguide surface 211 and the second waveguide surface 231. This may be because the reflection surfaces (the first reflection surface 221 and the second reflection surface 251) are inclined with respect to the first direction (for example, the +X direction).

According to some example implementations, the width w1 of the first waveguide 203 may be greater than the width w2 of the second waveguide 205. The width w1 of the first waveguide 203 may be the length of the first waveguide 203 in the second direction (for example, the +Z direction). The width w2 of the second waveguide 205 may be the length of the second waveguide 205 in the first direction (for example, the +X direction).

According to some example implementations, the width w1 of the first waveguide 203 may be equal to the width w3 of the mirror 204. The width w3 of the mirror 204 may be the length of the mirror 204 in the second direction.

According to some example implementations, the semiconductor package 1 may include insulation layers 135, 136, 137, 1525, 1526 and 1527. The insulation layers 135, 136, 137, 1525, 1526 and 1527 may surround the waveguide structure 200. For example, the first die 130 may include the insulation layers 135, 136 and 137. Each of the insulation layers 135, 136 and 137 may be named as ‘die insulation layer’. For example, the photonic integrated circuit chip 152 may include the insulation layers 1525, 1526 and 1527. Each of the insulation layers 1525, 1526 and 1527 may be named as ‘chip insulation layer’

According to some example implementations, the semiconductor package 1 may include the insulation layers 136 and 1526 surrounding one side of the first waveguide 203, and include the insulation layers 137 and 1527 surrounding the other side of the first waveguide 203. Each of the insulation layers 136 and 1526 may be named as ‘first insulation layer’. Each of the insulation layers 137 and 1527 may be named as ‘second insulation layer’. The first waveguide 203 may be surrounded by the first insulation layers 136 and 1526 and the second insulation layers 137 and 1527. The refractive index of each of the first insulation layers 136 and 1526 and the second insulation layers 137 and 1527 may be less than that of the first waveguide 203. Accordingly, the optical signal transmitted through the first waveguide 203 is totally reflected toward the interior of the first waveguide 203 at the boundary between the first and the second insulation layers 136, 137, 1526 and 1527 and the first waveguide 203, and then transmitted along the extension direction of the first waveguide 203.

According to some example implementations, the second waveguide 205 may be surrounded by the first insulation layers 136 and 1526. The second waveguide 205 may include a second perimeter surface 230a surrounded by the first insulation layers 136 and 1526. The refractive index of the first insulation layers 136 and 1526 may be smaller than the refractive index of the second waveguide 205.

Accordingly, the optical signal transmitted through the second waveguide 205 is totally reflected toward the interior of the second waveguide 205 at the boundary between the first insulation layers 136 and 1526 and the second waveguide 205, and then be transmitted along the extension direction of the second waveguide 205.

According to some example implementations, the semiconductor package 1 may include an insulation layer 135 and 1525 positioned between a first insulation layer (the first insulation layers 136 and 1526) and a second insulation layer (the second insulation layers 137 and 1527). Each of the insulation layers 135 and 1525 may be named as ‘interlayer insulation film’. The interlayer insulation films 135 and 1525 may come into contact with the mirror 204.

According to some example implementations, the first die 130 and the photonic integrated circuit chip 152 may be bonded. The first die 130 may include a first surface 130a bonded to the photonic integrated circuit chip 152. The photonic integrated circuit chip 152 may include a second surface 152a bonded to the first die 130. The first surface 130a and the second surface 152a may be bonded to each other. The first die 130 and the photonic integrated circuit chip 152 may be connected by direct bonding. For example, the first die 130 and the photonic integrated circuit chip 152 may be bonded by any one of a chip-to-wafer bonding method, a die-to-die bonding method and a chip-on-die bonding method. However, a semiconductor package according to another example implementation of the present disclosure may have a separate bonding film placed between the first surface of the first die and the second surface of the photonic integrated circuit chip.

According to some example implementations, the first die 130 and the photonic integrated circuit chip 152 may be bonded to each other with the 2-1 waveguide 230 and the second waveguide 260 aligned. The first die 130 may be named "die," the photonic integrated circuit chip 152 may be referred to as a "chip," the 2-1 waveguide 230 may be named the "first connection waveguide," and the second waveguide 260 may be named the "second connection waveguide." The first connection waveguide 230 and the second connection waveguide 260 may be aligned in the second direction (for example, the +Z direction). The first connection waveguide 230 may include a first connection waveguide surface 230c facing the second connection waveguide 260. The second connection waveguide 260 may include a second connection waveguide surface 260c facing the first connection waveguide 230. The first connection waveguide surface 230c and a second connection waveguide surface 260c may contact each other at the boundary where the die 130 and the chip 152 are bonded. However, in some example implementations of the present disclosure, a semiconductor package may have a first connection waveguide surface and a second connection waveguide surface spaced apart from each other near the boundary where the die and the chip are bonded.

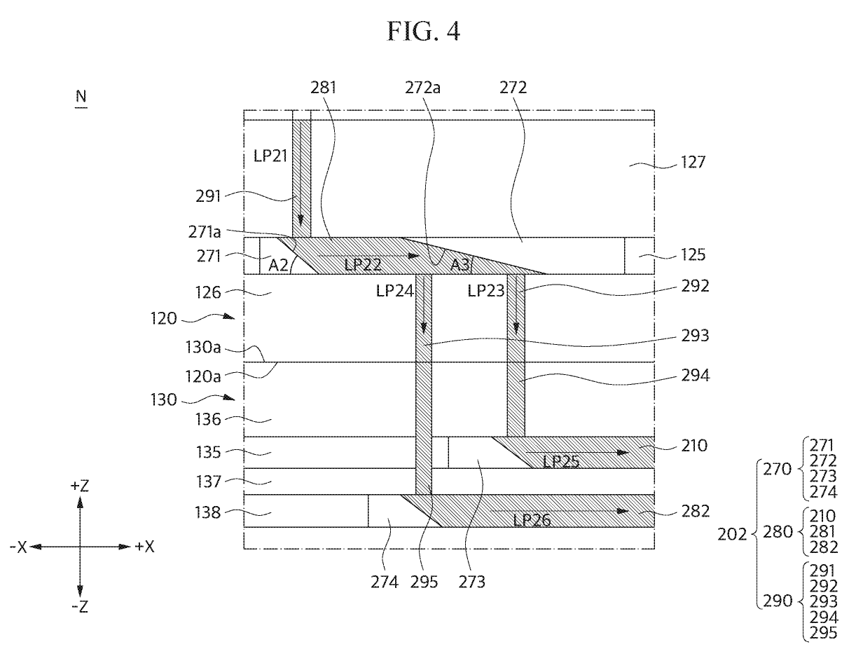

FIG. 4 is an enlarged view of a portion of a cross-sectional view of a semiconductor package according to some implementations. FIG. 4 may be an enlarged view of the N region shown in FIG. 2.

The descriptions on the first waveguide structure 201 with reference to FIG. 3 may be equally applied to the description of the second waveguide structure 202 described with reference to FIG. 4. For example, the second waveguide structure 202 may include a first waveguide 280, a second waveguide 290 and a mirror 270. The descriptions on the components with reference to FIG. 3 (for example, the first waveguide 203, the second waveguide 205 and the mirror 204) may be equally applied to descriptions on each of the first waveguide 280, the second waveguide 290 and the mirror 270.

In the semiconductor package 1 according to some implementations of the present disclosure, the "first waveguide" may be defined as a component that transmits an optical signal in the first direction (for example, the +X direction or the -X direction). In other words, the term "first waveguide" does not refer to a specific portion of the waveguide structure 200, but may indicate all portions of the waveguide structure 200 that transmit optical signals in the first direction (the +X direction or the -X direction). For example, the first waveguide 203 including the 1-1 waveguide 210 and the 1-2 waveguide 240 described with reference to FIG. 3 may indicate a "first waveguide" included in the first waveguide structure 201 that transmits an optical signal in the first direction (the +X direction or the -X direction). For example, the first waveguide 280 including the 1-1 waveguide 210, a first horizontal waveguide 281 and a second horizontal waveguide 282 described with reference to FIG. 4 may indicate a "first waveguide" included in the second waveguide structure 202 that transmits an optical signal in the first direction (the +X direction or the -X direction).

In the semiconductor package 1 according to some implementations of the present disclosure, the "second waveguide" may be defined as a component that transmits an optical signal in the second direction (for example, the +Z direction or the -Z direction). In other words, the term "second waveguide" does not refer only to a specific part of the waveguide structure 200, but may indicate all parts of the waveguide structure 200 that transmit optical signals in the second direction (the +Z direction or the -Z direction). For example, the second waveguide 205 including the 2-1 waveguide 230 and the second waveguide 260 described with reference to FIG. 3 may indicate a "second waveguide" included in the first waveguide structure 201 that transmits an optical signal in the second direction (the +Z direction or the -Z direction). For example, the second waveguide 290 including a first vertical waveguide 291, a second vertical waveguide (a 2-1 vertical waveguide 292 and a 2-2 vertical waveguide 294) and a third vertical waveguide (a 3-1 vertical waveguide 293 and a 3-2 vertical waveguide 295) described with reference to FIG. 4 may represent a "second waveguide" included in the second waveguide structure 202 that transmits optical signals in the second direction (the +Z direction or the -Z direction).

The descriptions on the insulation layers 135, 136, 137, 1525, 1526 and 1527 with reference to FIG. 3 may be equally applied to the description on the insulation layers 125, 126, 127, 135, 136, 137, 138 described with reference to FIG. 4. For example, the light-receiving structure 120 may include the insulation layers 126 and 127 surrounding the first waveguide 280, and the refractive index of the insulation layers 126 and 127 may be smaller than the refractive index of the first waveguide 280.

According to some example implementations, the second waveguide structure 202 may include the first waveguide 280. The description of the first waveguide 280 may be applied equally to the description of the first waveguide 203 described with reference to FIG. 3. For example, the first waveguide 280 may include the 1-1 waveguide 210 extending in the first direction (for example, the +X direction). The first waveguide 280 may include the first horizontal waveguide 281 and the second horizontal waveguide 282. The first horizontal waveguide 281 may extend in the first direction within the light-receiving structure 120. The second horizontal waveguide 282 may extend in the first direction within the first die 130. The 1-1 waveguide 210, the first horizontal waveguide 281 and the second horizontal waveguide 282 may be separated from each other in the second direction (for example, the +Z direction).

According to some example implementations, the second waveguide structure 202 may include the second waveguide 290. The description of the second waveguide 205 described with reference to FIG. 3 may be equally applied to description on the second waveguide 290. The second waveguide 290 may include the first vertical waveguide 291, a second vertical waveguide (the 2-1 vertical waveguide 292 and the 2-2 vertical waveguide 294), and a third vertical waveguide (the 3-1 vertical waveguide 293 and the 3-2 vertical waveguide 295). The first vertical waveguide 291 may be optically connected to an optical fiber (for example, the optical fiber 110 of FIG. 2). The first vertical waveguide 291 may connect the optical fiber 110 and the first horizontal waveguide 281. The second vertical waveguide (the 2-1 vertical waveguide 292 and the 2-2 vertical waveguide 294) may connect the first horizontal waveguide 281 and the 1-1 waveguide 210. The third vertical waveguide (the 3-1 vertical waveguide 293 and the 3-2 vertical waveguide 295) may connect the first horizontal waveguide 281 and the second horizontal waveguide 282. The second vertical waveguide (the 2-1 vertical waveguide 292 and the 2-2 vertical waveguide 294) and the third vertical waveguide (the 3-1 vertical waveguide 293 and the 3-2 vertical waveguide 295) may be spaced apart from each other in the first direction (for example, the +X direction).

According to some example implementations, the second vertical waveguide (the 2-1 vertical waveguide 292 and the 2-2 vertical waveguide 294) may include the 2-1 vertical waveguide 292 disposed inside the light-receiving structure 120 and the 2-2 vertical waveguide 294 disposed inside the first die 130. The 2-1 vertical waveguide 292 may extend from the first horizontal waveguide 281 toward the 2-2 vertical waveguide 294. The 2-2 vertical waveguide 294 may extend from the 1-1 waveguide 210 toward the 2-1 vertical waveguide 292.

According to some example implementations, the third vertical waveguide (the 3-1 vertical waveguide 293 and the 3-2 vertical waveguide 295) may include the 3-1 vertical waveguide 293 disposed inside the light-receiving structure 120 and the 3-2 vertical waveguide 295 disposed inside the first die 130. The 3-1 vertical waveguide 293 may extend from the first horizontal waveguide 281 toward the 3-2 vertical waveguide 295. The 3-2 vertical waveguide 295 may extend from the second horizontal waveguide 282 toward the 3-1 vertical waveguide 293.

According to some example implementations, the second waveguide structure 202 may include the mirror 270. The description on the mirror 204 with reference to FIG. 3 may be equally applied to descriptions on the mirror 270. The mirror 270 may include receiving structure mirrors (a first receiving structure mirror 271 and a second receiving structure mirror 272) and die structure mirrors (a first die structure mirror 273 and a second die structure mirror 274). The receiving structure mirrors (the first receiving structure mirror 271 and the second receiving structure mirror 272) may be arranged inside the light-receiving structure 120. The receiving structure mirrors (the first receiving structure mirror 271 and the second receiving structure mirror 272) may reflect an optical signal inside the first horizontal waveguide 281. The die structure mirrors (the first die structure mirror 273 and the second die structure mirror 274) may be placed inside the first die 130. The die structure mirrors (the first die structure mirror 273 and the second die structure mirror 274) may reflect the optical signal inside the 1-1 waveguide 210 or the second horizontal waveguide 282.

According to some example implementations, the receiving structure mirrors (the first receiving structure mirror 271 and the second receiving structure mirror 272) may include the first receiving structure mirror 271 and the second receiving structure mirror 272. The first receiving structure mirror 271 may include a first receiving structure mirror reflection side 271a facing the first vertical waveguide 291. The second receiving structure mirror 272 may include a second receiving structure mirror reflection side 272a facing the 2-1 vertical waveguide 292 and the 3-1 vertical waveguide 293. The first receiving structure mirror reflection side 271a and the second receiving structure mirror reflection side 272a may be inclined with respect to the extension direction of the first waveguide (for example, the first horizontal waveguide 281). A first inclination angle A2 of the first receiving structure mirror reflection side 271a and a second inclination angle A3 of the second receiving structure mirror reflection side 272a may be different. For example, the first inclination angle A2 may be larger than the second inclination angle A3. This may be because the second receiving structure mirror 272 faces both the 2-1 vertical waveguide 292 and the 3-1 vertical waveguide 293.

According to some example implementations, die structure mirrors (the first die structure mirror 273 and the second die structure mirror 274) may include the first die structure mirror 273 and the second die structure mirror 274. The first die structure mirror 273 may face the 2-2 vertical waveguide 294 and the 1-1 waveguide 210. The second die structure mirror 274 may face the 3-2 vertical waveguide 295 and the second horizontal waveguide 282.

According to some example implementations, an optical signal transmitted from an optical fiber (for example, the optical fiber 110 of FIG. 2) to the light-receiving structure 120 may be transmitted to a first path LP21 through the first vertical waveguide 291. The optical signal transmitted to the first path LP21 may be reflected on the first receiving structure mirror 271 and transmitted to the first horizontal waveguide 281. The optical signal may be transmitted along a second path LP22 inside the first horizontal waveguide 281 and reflected on the second receiving structure mirror 272. The optical signal reflected on the second receiving structure mirror 272 may be transmitted to the second vertical waveguide (the 2-1 vertical waveguide 292 and the 2-2 vertical waveguide 294) along a third path LP23, or may be transmitted to the third vertical waveguide (the 3-1 vertical waveguide 293 and the 3-2 vertical waveguide 295) along a fourth path LP24. The optical signal transmitted to the second vertical waveguide (the 2-1 vertical waveguide 292 and the 2-2 vertical waveguide 294) along the third path LP23 may be reflected by the first die structure mirror 273 and transmitted to the 1-1 waveguide 210 along a fifth path LP25. The optical signal transmitted to the third vertical waveguide (the 3-1 vertical waveguide 293 and the 3-2 vertical waveguide 295) along the fourth path LP24 may be reflected by the second die structure mirror 274 and transmitted to the second horizontal waveguide 282 along a sixth path LP26.

A waveguide structure according to some implementations of the present disclosure (for example, the waveguide structure 200 of FIG. 2) may transmit optical signals to all of a plurality of chip assemblies (for example, the chip assembly 150 of FIG. 2) that are spaced apart from each other by forming the structures and arrangements of the first waveguide, the second waveguide, and the mirror of the first waveguide structure 201 and the second waveguide structure 202 differently.

According to some example implementations, the first die 130 and the light-receiving structure 120 may be bonded. The light-receiving structure 120 may include a structure surface 120a that is bonded to the first die 130. The first die 130 may include the first surface 130a bonded to the light-receiving structure 120. The first surface 130a and the structure surface 120a may be bonded to each other. The first die 130 and the light-receiving structure 120 may be joined by direct bonding. For example, the first die 130 and the light-receiving structure 120 may be bonded by any one of a chip-to-wafer bonding method, a die-to-die bonding method, and a chip- on-die bonding method. However, a semiconductor package according to some implementations of the present disclosure may have a separate bonding film disposed between a first surface of a first die and a structure surface of a light-receiving structure.

According to some example implementations, the first die 130 and the light-receiving structure 120 may be bonded to each other with the 2-1 vertical waveguide 292 and the 2-2 vertical waveguide 294 aligned. The 2-1 vertical waveguide 292 and the 2-2 vertical waveguide 294 may be aligned in the second direction (for example, the +Z direction). The 2-1 vertical waveguide 292 and the 2-2 vertical waveguide 294 may contact each other at the boundary where the first die 130 and the light-receiving structure 120 are bonded. However, in some implementations of the present disclosure, a semiconductor package may include the 2-1 vertical waveguide and the 2-2 vertical waveguide separated from each other near the boundary where the first die and the light-receiving structure are bonded.

According to some example implementations, the first die 130 and the light-receiving structure 120 may be bonded to each other with the 3-1 vertical waveguide 293 and the 3-2 vertical waveguide 295 aligned. The 3-1 vertical waveguide 293 and the 3-2 vertical waveguide 295 may be aligned in the second direction (for example, the +Z direction). The 3-1 vertical waveguide 293 and the 3-2 vertical waveguide 295 may contact each other at the boundary where the first die 130 and the light-receiving structure 120 are bonded. However, according some implementations, the semiconductor package may have the 3-1 vertical waveguide and 3-2 vertical waveguide separated from each other near the boundary where the first die and the light-receiving structure are bonded.

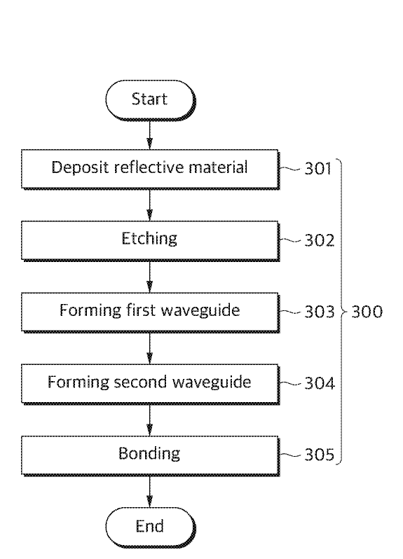

FIG. 5 is a block diagram illustrating a method 300 for manufacturing the waveguide structure 200 according to some implementations.

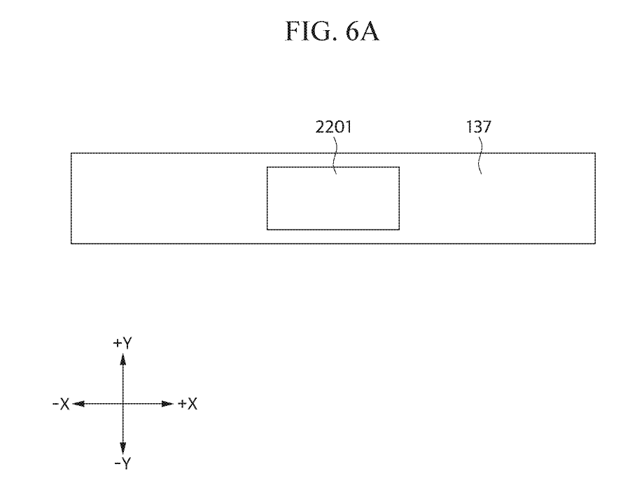

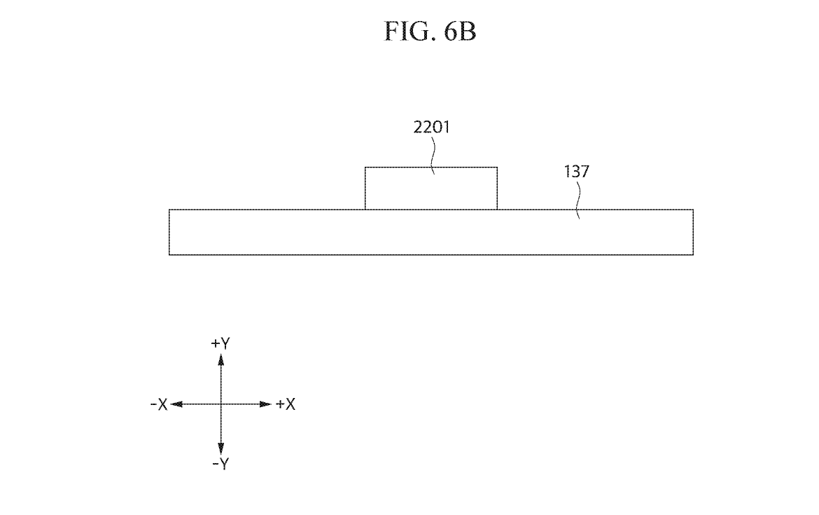

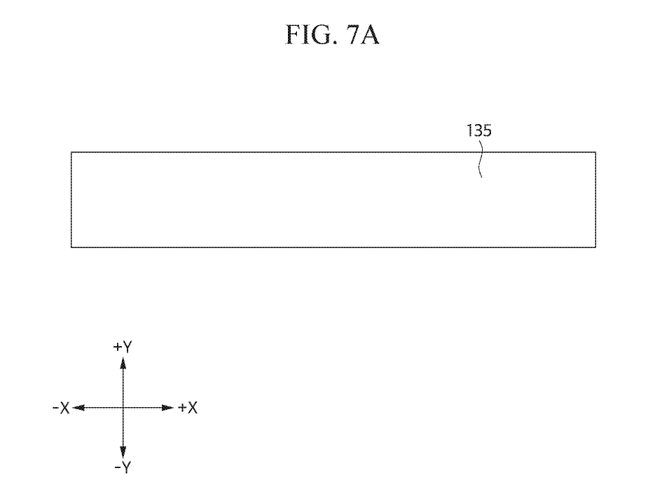

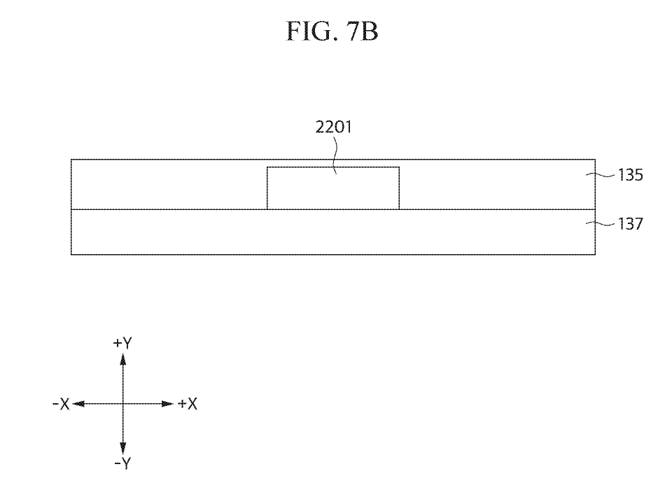

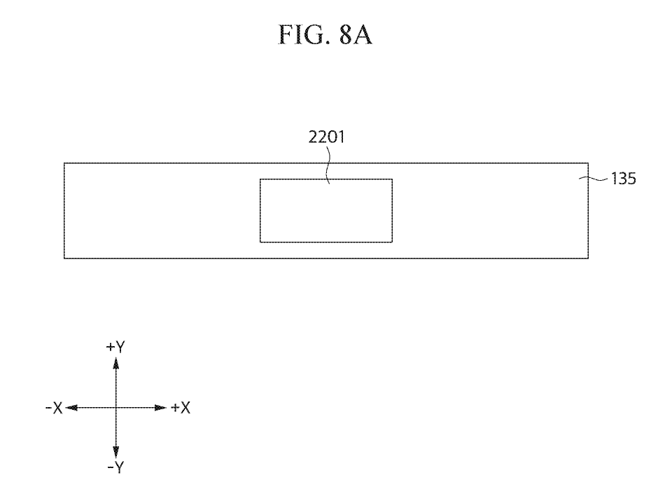

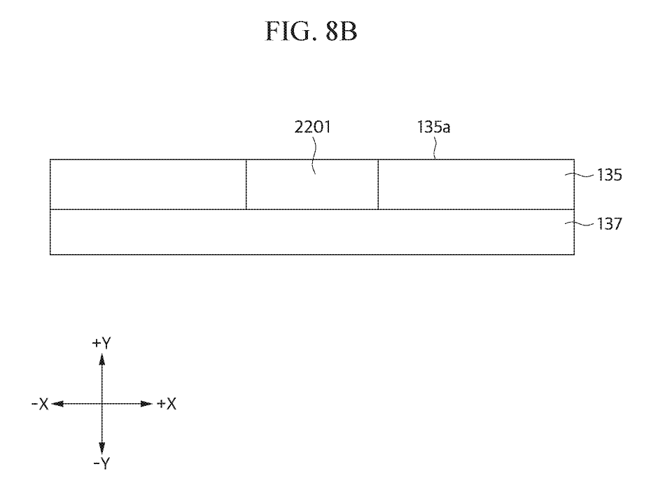

According to some example implementations, the method 300 for manufacturing the waveguide structure 200 may include depositing a reflective material in operation 301. The depositing the reflective material in operation 301 may include a manufacturing method described with reference to FIG. 6A, FIG. 6B, FIG. 7A, FIG. 7B, FIG. 8A and FIG. 8B.

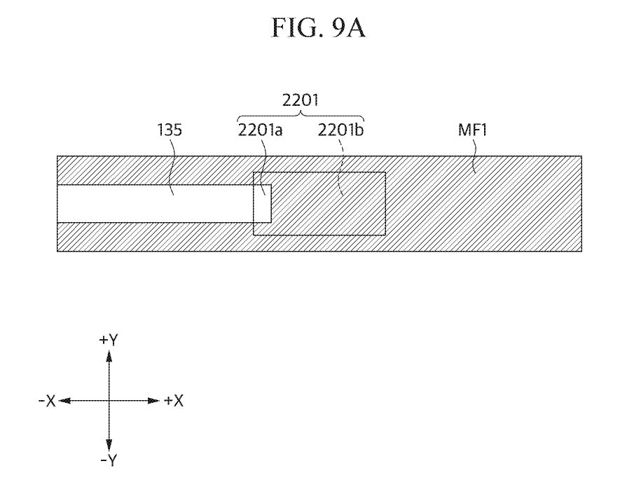

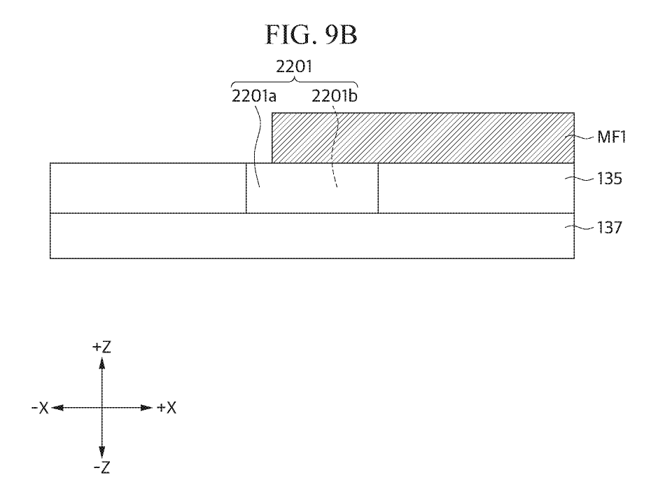

According to some example implementations, the method 300 for manufacturing the waveguide structure 200 may include etching in operation 302. In operation 302, the etching may include a manufacturing method described with reference to FIG. 9A and FIG. 9B.

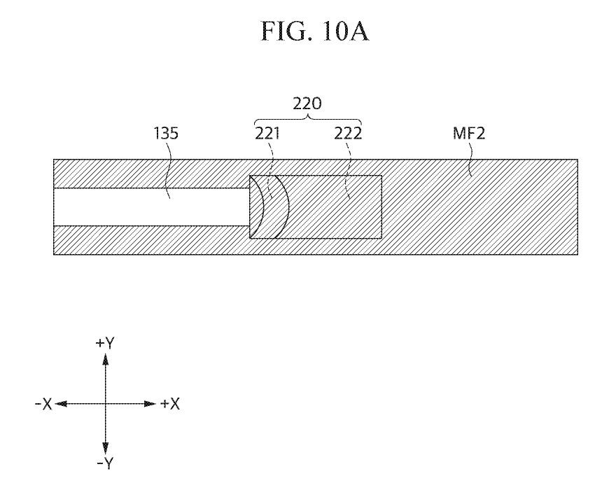

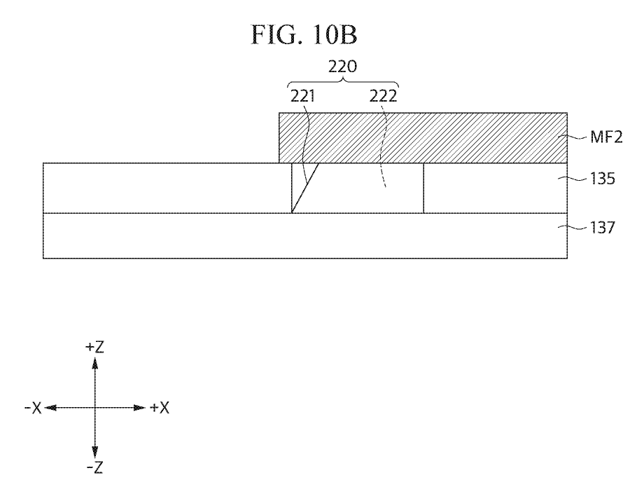

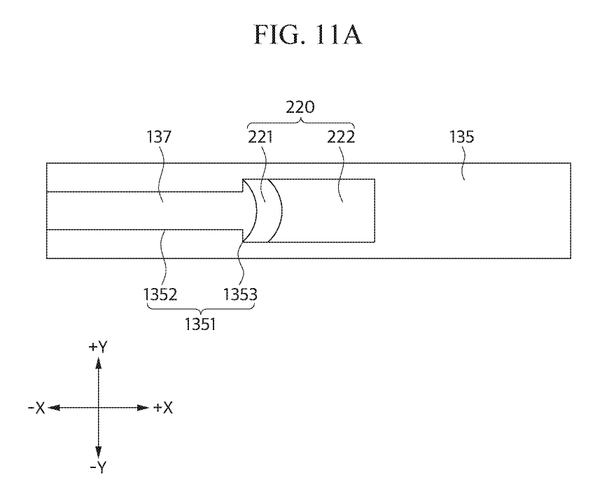

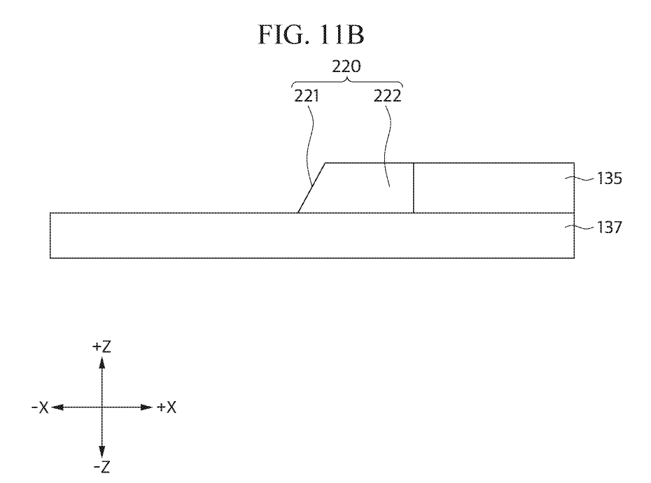

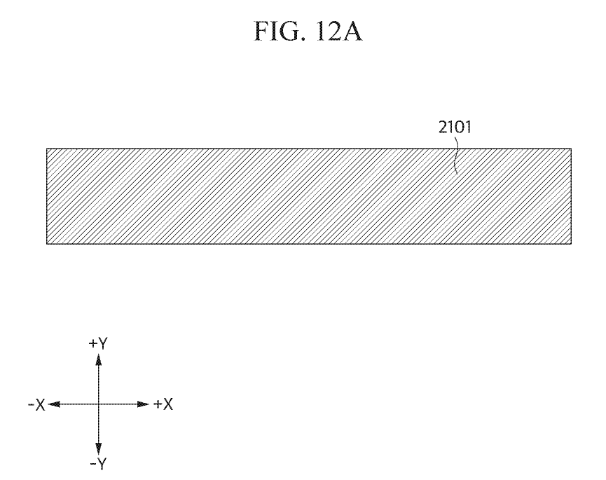

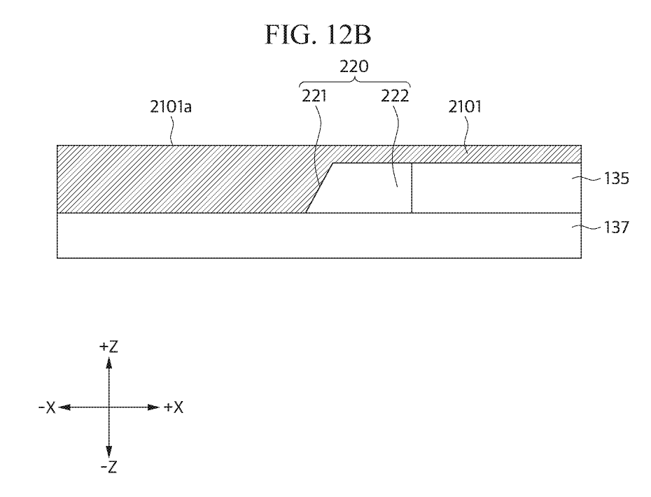

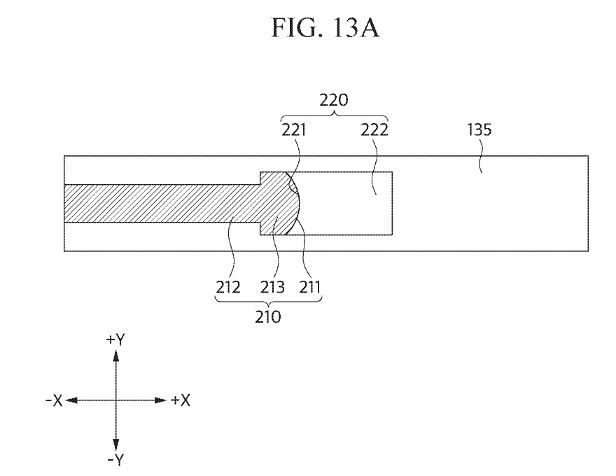

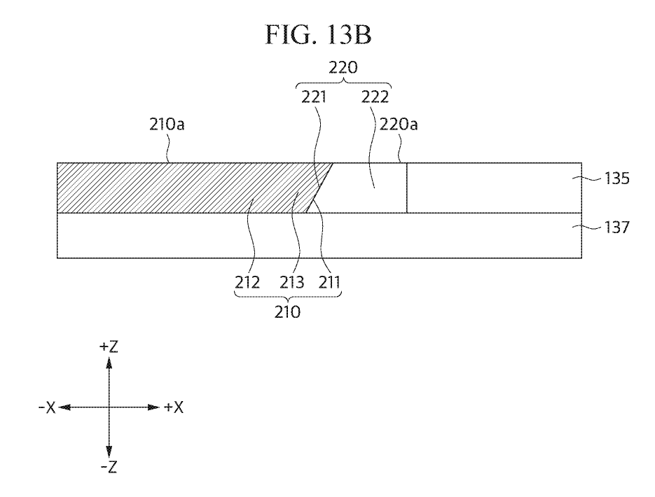

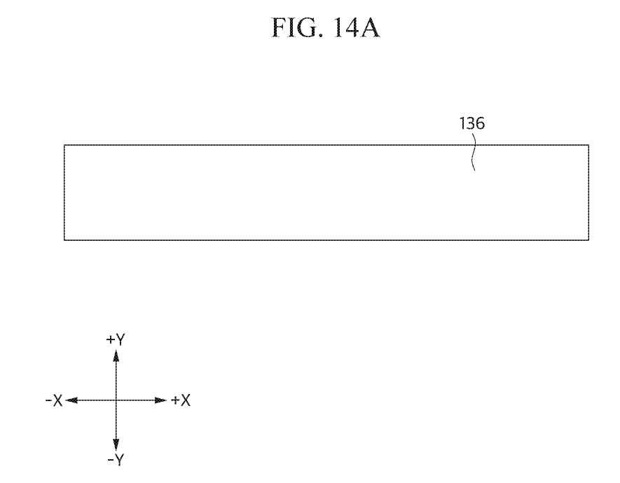

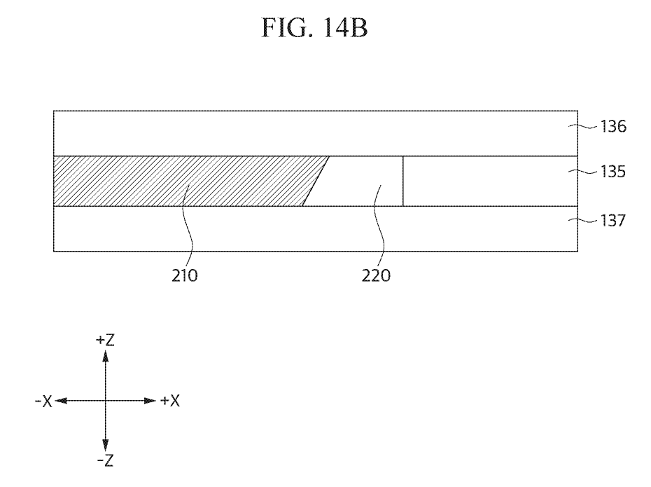

According to some example implementations, the method 300 for manufacturing the waveguide structure 200 may include forming the first waveguide 203 in operation 303. In operation 303, forming the first waveguide 203 may include a manufacturing method described with reference to FIG. 10A, FIG. 10B, FIG. 11A, FIG. 11B, FIG. 12A, FIG. 12B, FIG. 13A, FIG. 13B, FIG. 14A and FIG. 14B.

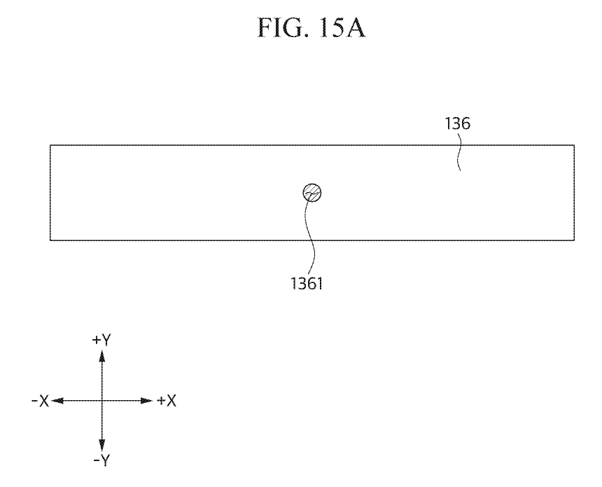

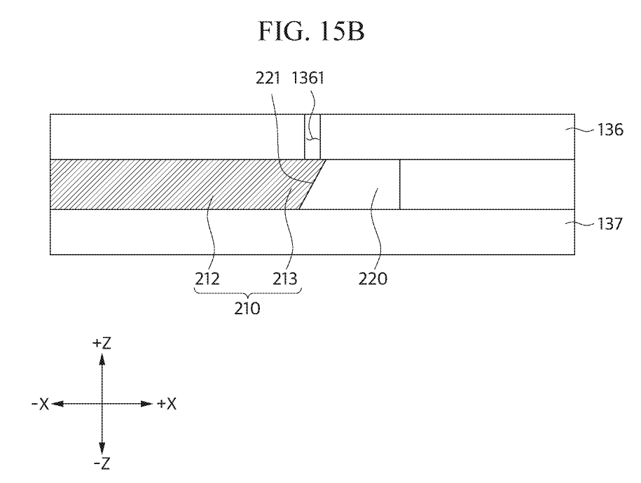

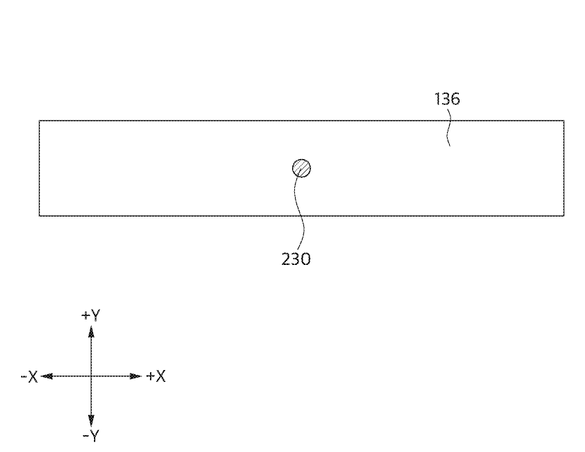

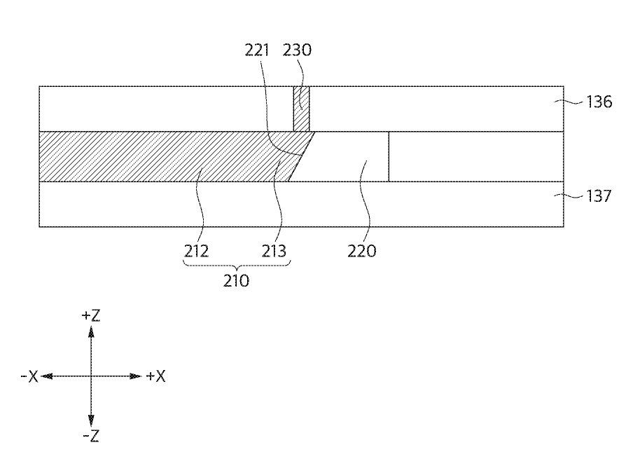

According to some example implementations, the method 300 for manufacturing the waveguide structure 200 may include forming the second waveguide 205 in operation 304. In operation 304, forming the second waveguide 205 may include a manufacturing method described with reference to FIG. 15A, FIG. 15B, FIG. 16A and FIG. 16B.

According to some example implementations, the method 300 for manufacturing the waveguide structure 200 may include bonding in operation 305. In operation 305, the bonding may include a method of bonding a light-receiving structure (for example, the light-receiving structure 120 of FIG. 2) and a chip assembly (for example, the chip assembly 150 of FIG. 2) on a first die (for example, the first die 130 of FIG. 2) by a direct bonding method.

FIG. 6A to FIG. 16B are drawings illustrating a manufacturing method of the waveguide structure 200 according to some implementations.

In the method of manufacturing the waveguide structure 200 described with reference to FIG. 6A, FIG. 6B, FIG. 7A, FIG. 7B, FIG. 8A, FIG. 8B, FIG. 9A, FIG. 9B, FIG. 10A, FIG. 10B, FIG. 11A, FIG. 11B, FIG. 12A, FIG. 12B, FIG. 13A, FIG. 13B, FIG. 14A, FIG. 14B, FIG. 15A, FIG. 15B, FIG. 16A and FIG. 16B, methods for manufacturing the 1-1 waveguide 210, the first mirror 220, and the 2-1 waveguide 230 are described as representative example implementations. The methods for manufacturing the 1-1 waveguide 210, the first mirror 220 and the 2-1 waveguide 230 described with reference to FIG. 6A, FIG. 6B, FIG. 7A, FIG. 7B, FIG. 8A, FIG. 8B, FIG. 9A, FIG. 9B, FIG. 10A, FIG. 10B, FIG. 11A, FIG. 11B, FIG. 12A, FIG. 12B, FIG. 13A, FIG. 13B, FIG. 14A, FIG. 14B, FIG. 15A, FIG. 15B, FIG. 16A and FIG. 16B may be the same as the methods for manufacturing the 1-2 waveguide 240, the second mirror 250 and the second waveguide 260. The methods for manufacturing the 1-1 waveguide 210, the first mirror 220 and the 2-1 waveguide 230 described with reference to FIG. 6A, FIG. 6B, FIG. 7A, FIG. 7B, FIG. 8A, FIG. 8B, FIG. 9A, FIG. 9B, FIG. 10A, FIG. 10B, FIG. 11A, FIG. 11B, FIG. 12A, FIG. 12B, FIG. 13A, FIG. 13B, FIG. 14A, FIG. 14B, FIG. 15A, FIG. 15B, FIG. 16A and FIG. 16B may be understood as a method of manufacturing the first waveguide 203, the mirror 204, and the second waveguide 205.

Referring to FIG. 6A and FIG. 6B, a reflective material 2201 may be placed on the second insulation layer 137. The reflective material 2201 may contain at least one of aluminum (Al), copper (Cu), titanium (Ti) and tungsten (W).

Referring to FIG. 7A and FIG. 7B, the reflective material 2201 may be surrounded by the interlayer insulation film 135. The interlayer insulation film 135 may contain at least one of silicon (Si), oxide and nitride.

Referring to FIG. 8A and FIG. 8B, a surface 135a of the interlayer insulation film 135 may be cut so that the reflective material 2201 is exposed to the outside. The interlayer insulation film 135 may be cut by the chemical mechanical polishing (CMP) process.

Referring to FIG. 9A and FIG. 9B, a first mask MF1 may be positioned so as to cover at least a portion of the reflective material 2201. Only a part of the reflective material 2201 may be exposed to the outside by the first mask MF1. The reflective material 2201 may be divided into a first part 2201a exposed to the outside of the first mask MF1 and a second part 2201b covered by the first mask MF1. Afterwards, an etching process (for example, wet etching) may be performed using a material having etch selectivity for the reflective material 2201. By the etching process, the first part 2201a may be etched, and the second part 2201b may not be etched.

Referring to FIG. 10A and FIG. 10B, the mirror 220 may be formed by the etching process described with reference to FIG. 9A and FIG. 9B. The mirror 220 may include the reflection surface 221 formed on the first part 2201a not covered by the first mask MF1 and a mirror body 222 formed on the second part 2201b covered by the first mask MF1. After then, a second mask MF2 may be positioned to cover at least a portion of the interlayer insulation film 135, and the interlayer insulation film 135 may be etched using a material having etch selectivity.

Referring to FIG. 11A and FIG. 11B, at least a portion of the interlayer insulation film 135 may be etched by the etching process described with reference to FIG. 10A and FIG. 10B. A portion of the interlayer insulation film 135 may be etched to form a recess 1351. The recess 1351 may include a first recess 1352 and a second recess 1353 having different widths. The width of the second recess 1353 in contact with a reflection surface 2202 may be greater than the width of the first recess 1352.

Referring to FIG. 12A and FIG. 12B, a material 2101 forming a waveguide may be placed on the insulation layers 135 and 137. The material 2101 forming the waveguide may include at least one of silicon (Si), oxide and nitride. A surface 2101a of the material 2101 forming the waveguide may be spaced apart from the mirror 220.

Referring to FIG. 13A and FIG. 13B, the first waveguide 210 may be formed by cutting the surface 2101a of the material 2101 forming the waveguide. The surface 2101a of the material 2101 forming the waveguide may be cut by the chemical mechanical polishing (CMP) process. The first perimeter surface 210a of the first waveguide 210 and the mirror surface 220a of the mirror 220 may be located on the same plane. The first waveguide 210 may include an extension part 212 extending toward the mirror 220, and an expansion part 213 positioned between the extension part 212 and the mirror 220 and including the first waveguide surface 211. The extension part 212 may be formed within the first recess 1352 as shown in FIG. 11A, and the expansion part 213 may be formed within the second recess 1353 as illustrated in FIG. 11A. Since the widths of the first recess 1352 and the second recess 1353 are different, the width of the extension part 212 may be smaller than the width of the expansion part 213.

Referring to FIG. 14A and FIG. 14B, the first insulation layer 136 may be placed on the first waveguide 210 and the mirror 220.

Referring to FIG. 15A and FIG. 15B, a hole 1361 may be formed in the first insulation layer 136. A portion (for example, the expansion part 213) of the first waveguide 210 may be exposed to the outside of the first insulation layer 136 through the hole 1361.

Referring to FIG. 16A and FIG. 16B, the second waveguide 230 may be formed inside the hole 1361. The second waveguide 230 may include at least one of silicon (Si), oxide and nitride. The second waveguide 230 may be connected to the first waveguide 210. The second waveguide 230 may be connected to the expansion part 213 of the first waveguide 210.

A method for manufacturing a semiconductor package according to some implementations may include depositing a reflective material.

A method for manufacturing a semiconductor package according to some implementations may include etching the reflective material to form a mirror including a reflection surface.

A method for manufacturing a semiconductor package according to some implementations may include forming a first waveguide extending in a first direction and contacting the reflection surface.

A method for manufacturing a semiconductor package according to some implementations may include forming a second waveguide extending from the first waveguide in a second direction intersecting the first direction.

In the above, various implementations of the present disclosure are described in detail. However, it will be apparent to those with average knowledge in the technical field that scope of rights of this disclosure is not limited thereto, and various modifications and variations are possible without departing from the technical spirit of the present disclosure as set forth in the claims. Further, the above-described example implementations may be implemented with some elements deleted, and each example implementation may be implemented in combination with each other.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A semiconductor package, comprising:
an optical fiber configured to transmit an optical signal;
a photonic integrated circuit chip configured to convert the optical signal received from the optical fiber into an electrical signal;
an electric circuit configured to receive the electrical signal; and
a waveguide structure connecting the optical fiber and the photonic integrated circuit chip, and configured to transmit the optical signal to the photonic integrated circuit chip,
wherein the waveguide structure comprises:
a first waveguide extending in a first direction,
a mirror comprising a reflection surface configured to reflect the optical signal in the first waveguide in a second direction towards the photonic integrated circuit chip, and
a second waveguide configured to receive the optical signal reflected from the reflection surface wherein the second waveguide extends in the second direction from the first waveguide toward the photonic integrated circuit chip.

2. The semiconductor package of claim 1, wherein the first waveguide comprises a first waveguide surface facing the reflection surface, and
wherein the second waveguide comprises a second waveguide surface facing the reflection surface.

3. The semiconductor package of claim 2, wherein the first waveguide comprises:
the first waveguide surface that is in contact with the reflection surface; and
a first perimeter surface that is in contact with the second waveguide surface.

4. The semiconductor package of claim 1, wherein the first waveguide comprises:
a 1-1 waveguide extending in the first direction; and
a 1-2 waveguide extending in the first direction, and that is spaced apart from the 1-1 waveguide in the second direction, and
wherein the second waveguide comprises:
a 2-1 waveguide extending from the 1-1 waveguide toward the 1-2 waveguide; and
a 2-2 waveguide extending from the 1-2 waveguide toward the 1-1 waveguide.

5. The semiconductor package of claim 4, wherein the 2-1 waveguide and the 2-2 waveguide are aligned in the second direction.

6. The semiconductor package of claim 4, wherein the mirror comprises:
a first mirror facing each of the 1-1 waveguide and the 2-1 waveguide; and
a second mirror facing each of the 1-2 waveguide and the 2-2 waveguide.

7. The semiconductor package of claim 1, comprising:
a first insulation layer in contact with a first side of the first waveguide facing in the second direction and having a first refractive index; and
a second insulation layer that is in contact with a second side of the first waveguide opposite the first side of the waveguide and having a second refractive index,
wherein a refractive index of the first waveguide is greater than the first refractive index and the second refractive index.

8. The semiconductor package of claim 1, wherein a first length of the first waveguide in the second direction is greater than a second length of the second waveguide in the first direction.

9. The semiconductor package of claim 1, wherein a first length of the first waveguide in the second direction is identical to a third length of the mirror in the second direction.

10. The semiconductor package of claim 1, wherein the reflection surface faces the first waveguide in the first direction, and is inclined at an angle to face the second waveguide in the second direction, the angle ranging between 40 and 50 degrees with respect to the first direction.

11. A semiconductor package, comprising:
an optical fiber;
a die comprising a first surface and a first connection waveguide that is extending toward the first surface and configured to transmit an optical signal incident on the first connection waveguide through the optical fiber; and
a chip comprising a second surface facing the first surface and a second connection waveguide extending toward the second surface to receive the optical signal through the first connection waveguide,
wherein the die and the chip are stacked on each other, the first surface and the second surface are bonded to each other, and the first connection waveguide and the second connection waveguide are aligned in a direction that the die and the chip are stacked.

12. The semiconductor package of claim 11, wherein the first connection waveguide comprises a first connection waveguide surface facing the second connection waveguide,
wherein the second connection waveguide comprises a second connection waveguide surface facing the first connection waveguide, and
wherein the first connection waveguide surface and the second connection waveguide surface are facing each other and are in contact at a boundary where the first surface and the second surface are bonded.

13. The semiconductor package of claim 11, wherein the die comprises a 1-1 waveguide extending parallel to the first surface and spaced apart from the first surface,
wherein the chip comprises a 1-2 waveguide extending parallel to the second surface and spaced apart from the second surface, and
wherein the first connection waveguide extends from the 1-1 waveguide toward the first surface, and the second connection waveguide extends from the 1-2 waveguide toward the second surface.

14. The semiconductor package of claim 11, wherein the die comprises a first mirror reflecting light toward the first surface,
wherein the chip comprises a second mirror reflecting light toward the second surface, and
wherein the first connection waveguide extends between the first mirror and the first surface, and the second connection waveguide extends between the second mirror and the second surface.

15. The semiconductor package of claim 11, wherein the die comprises a die insulation layer that defines the first surface and surrounds the first connection waveguide, and
wherein the chip comprises a chip insulation layer that defines the second surface, surrounds the second connection waveguide, and is bonded with the die insulation layer.

16. A semiconductor package, comprising:
an optical fiber; and
a waveguide structure configured to transmit to a photonic integrated chip an optical signal incident on the waveguide structure through the optical fiber,
wherein the waveguide structure comprises:
a mirror comprising a reflection surface; and
a first waveguide extending toward the mirror and comprising a first waveguide surface that is in contact with the reflection surface.

17. The semiconductor package of claim 16, wherein the reflection surface is inclined with respect to a direction that the first waveguide extends, and the first waveguide surface is inclined at an angle identical to the reflection surface.

18. The semiconductor package of claim 16, wherein the waveguide structure comprises a second waveguide that faces the reflection surface and extends in a direction intersecting the first waveguide, and
wherein the first waveguide comprises a first perimeter surface that is in contact with the second waveguide.

19. The semiconductor package of claim 16, wherein the first waveguide comprises a first perimeter surface, and the mirror comprises a mirror surface that is located on a plane identical to a plane of the first perimeter surface.

20. The semiconductor package of claim 16, wherein the first waveguide comprises:
an extension part extending toward the mirror in a first direction and having a first width in a direction perpendicular to the first direction; and
an expansion part between the extension part and the mirror, the expansion part comprising the first waveguide surface that is in contact with the mirror, and having a second width that is greater than the first width.
